(19) United States
(12) Patent Application Publication
(10) Pub. No.: US 2010/0008075 A1
(43) Pub. Date: Jan. 14, 2010

(54) SELF LEVELLING ILLUMINATION DEVICE

(75) Inventors: Charles Lin, North Ryde (AU); Tristan Trimnell-Ritchard, North Ryde (AU)

Correspondence Address: SHERIDAN ROSS PC, 1560 BROADWAY, SUITE 1200, DENVER, CO, 80202, US

(73) Assignee: LINFIELD PACIFIC PTY LTD, North Ryde (AU)

(21) Appl. No.: 12/279,043

(22) PCT Filed: Feb. 13, 2007
(86) PCT No.: PCT/AU07/00153

§ 371 Date: Dec. 30, 2008

(30) Foreign Application Priority Data
Feb. 13, 2006 (AU) 2006900674

(51) Int. Cl. F21L 4/00; F21L 13/00

(52) U.S. Cl. 362/158; 362/192

(57) ABSTRACT

An illumination device for insertion entirely inside a typical novelty balloon or the like, said device including: an outer casing having a lower and an upper component and having a substantially spherical or ovoid overall shape, capable of rolling through at least one full revolution on a flat surface; a power source mounted inside said outer casing; and a light generator connected to said power source and mounted inside said outer casing such that light generated by said generator is directed substantially through said upper component; wherein the centre of gravity of said device is located within said lower component of said outer casing.

### FIELD OF THE INVENTION

The invention relates to the field of mass manufactured novelty items. In particular, the invention relates to an improved illumination device, suitable for internally illuminating balloons.

### BACKGROUND OF THE INVENTION

In the field of novelty items, particularly for use at outdoor festivals, parties and the like, a very popular item is the helium- or air-filled balloon. These may be used as decorations or may be carried, usually by children, and used as a toy or promotional tool.

More recently, it has been found that the attractiveness of these items, especially for indoor or evening events, can be greatly enhanced by internally illuminating the balloon with a suitable illumination device.

Such illumination devices have included light sources which may be inserted partly through the neck of the balloon, and which effectively seal the neck of the balloon. These light sources have included electrically powered lights.

However, these devices tend to be bulky and require that the balloon must be inflated and sealed in a specific manner. They also tend to add weight to the balloon, with the result that helium-filled balloons may be unable to achieve buoyancy in the air.

Smaller devices have been developed which can be inserted, in their entirety, into the balloon which can assist in alleviating some of the above disadvantages. However, a disadvantage associated with these devices is that the direction of light emission from them is relatively uncontrolled once they are installed inside the balloon. For example, the light emission point may be located underneath the device as it comes to rest inside the balloon, meaning that the emitted light may not be directed in a manner appropriate to the illumination of the whole balloon.

These devices also usually require the use of O-rings to hold then in place in the balloon, which make them relatively complicated insert and use.

Accordingly, it is an object of the invention to provide an illumination device, suitable for internal illumination of a balloon or the like, which exhibits an ability to consistently direct light into the greater portion of said balloon thereby to illuminate said balloon.

### SUMMARY OF THE INVENTION

An illumination device for insertion entirely inside a typical novelty balloon or the like, said device including:

an outer casing having a lower and an upper component and having a substantially spheroid in overall shape, capable of rolling through at least one full revolution on a flat surface;

a power source mounted inside said outer casing; and

a light generator connected to said power source and mounted inside said outer casing such that light generated by said generator is directed outward substantially through said upper component;

wherein the centre of gravity of said device is located within said lower component of said outer casing.

The design of the device having a shape capable of rolling and having a centre of gravity located away from the point of light emission provides the advantage that the device will tend to self-level such that the light emission will be directed upwardly into the internal chamber of, for example, a balloon. Self levelling may be enhanced by providing an at least partially flattened portion located at the preferred bottom position of the device. This flattened portion may advantageously incorporate a ‘sticky’ or adhesive layer which enhances the ability of the device to remain in place.

Preferably, said lower component of said outer casing is substantially heavier than said upper component. This provides a relatively simple and cost effective way to provide a lower centre of gravity for the device. Advantageously, said lower component of said outer casing is substantially composed of a relatively high density material, such as metal or high density plastic, and said upper component is substantially composed of relatively lower density material, such as a low density plastic, which is also capable of light transmission.

An alternative, or potentially complementary, design feature for said device is to provide a power source consisting of one or more batteries, wherein said batteries are substantially housed in said lower component of said outer casing. The mass of the batteries is equally likely to provide a low centre of gravity, or to enhance that provided by a lower component of relatively high density material such as metal or high density plastic.

Preferably said light generator is one or more light emitting diodes, being relatively light-weight and providing good aesthetic appearance.

Advantageously, further enhancement may be provided wherein a switch mechanism is incorporated the device, said mechanism arising from an internal configuration of the power source and the light generator wherein the former is brought into electrical contact with the latter via relative twisting of the upper and lower casing components.

Alternatively, or in addition, there may advantageously be incorporated a switch mechanism whereby the mode of operation of the light source may be switched between different modes, said mechanism being actuated by relative twisting of the upper and lower casing components. For example, this switch mechanism may be employed to switch the operation of the light source between a constant beam of light and a flickering beam of light, or to a light source colour-changing mode.

Advantageously, an adhesive substance may be applied to the surface of the lower component of the outer casing thereby to allow the device to adhere to a surface.

In another aspect, the invention provides an illuminated balloon, said illumination being provided by an illumination device as described above.

Now will be described, by way of a specific, non-limiting example, a preferred embodiment of the invention.

### BRIEF DESCRIPTION OF THE FIGURES

FIG. 1 is an elevation view of an illumination device according to the invention.

FIG. 2 is a sectional view of the illumination device depicted in FIG. 1.

FIG. 3 is an exploded view of the two main portions of the outer casing of the illumination device of FIG. 1.

FIG. 4 is an illustration of the illumination device depicted in FIG. 1 in place in a balloon being carried by a child.

### DETAILED DESCRIPTION OF A PREFERRED EMBODIMENT

The following description relates to a self levelling illumination device suitable for insertion in a typical novelty balloon very familiar to those skilled in the art. Such balloons may be provided in a number of shapes when inflated. Said balloons feature, when inflated, a main internal ‘chamber’ which provides the bulk of the balloon volume and a neck via which the balloon chamber is inflated with air or any other suitable gas.

The device provides sufficient light for said internal ‘chamber’ of the balloon to be illuminated so as to be readily visible in a relatively dark environment, such as outdoors at night.

The device is designed so as to be inserted wholly within the balloon, via the neck of the balloon. Typically, the device is adapted to be manufactured at relatively low cost, and is therefore anticipated to be disposable, having a single use.

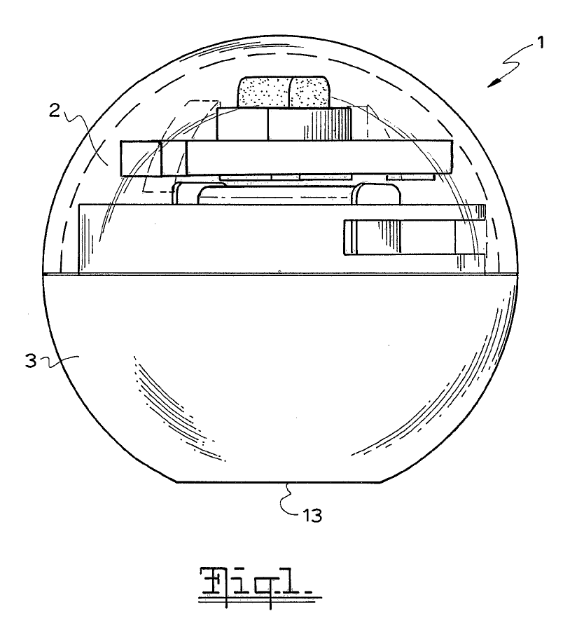

Turning to FIG. 1, there is depicted an external view of a device 1 according to the invention. The outer casing of the device consists of an upper component 2 and a lower component 3. Preferably, the upper component 2 is made from a relatively less dense transparent plastic material, for example ABS plastic, and the lower component 3 is made from a more dense material, such as a metal, for example steel or copper, or a high density ABS plastic.

The device 1 is substantially spherical in shape as depicted. It will be appreciated by those skilled in the art, however, that suitable alternative shapes, for example oblate or prolate spheroids, could be used. The important feature is that the shape allows the device to self level by rolling to a preferred position.

This choice of shape and materials ensures that the device is substantially heavier at the bottom, i.e. that the centre of gravity of the device is located within the lower component 3 of the device 1. Accordingly, the device, if placed on a supporting surface, can roll into an upright position as described above, regardless of the position it which the device is originally placed on said surface. This ability may be further enhanced by provision of a relatively flat spot at the preferred base position 13. This flat portion may further incorporate the addition of a relatively ‘sticky’ substance that will cause the device to remain in its final resting place.

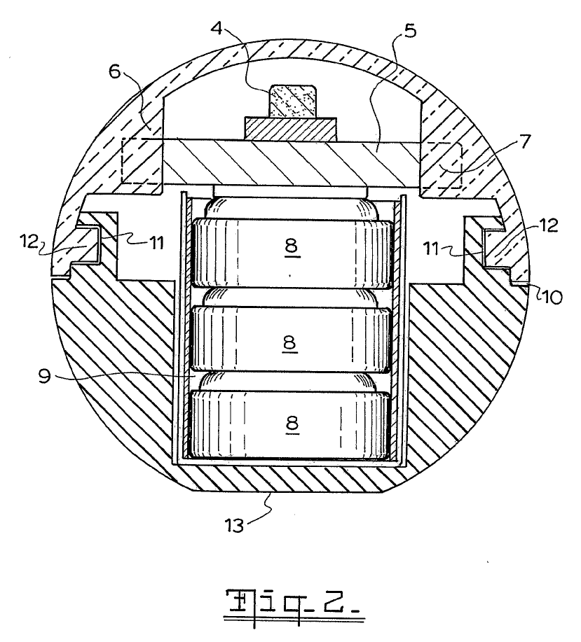

As it is desired that the device 1 sit at the bottom of the internal chamber of the balloon into which it is inserted, it is accordingly preferable for the light to emanate upwardly from the top of the device 1. Accordingly, as can be seen in FIG. 2, the device is internally configured so that the light source 4, preferably one or more light emitting diodes (LEDs), is directed to emit light upwardly through the plastic upper component 2 of the casing. The light source 4 is located adjacent said plastic upper component 2, to maximise light transmission out of the device 1.

In this preferred embodiment, the LED is located in a printed circuit board (PCB) 5, which is suspended between two anchor points (6, 7) located in the upper component of the casing 2.

The PCB 5 is also located so as to contact a stack of batteries 8, located in a cavity 9 in the lower component 3 of the casing, which provides power to the LEDs 4. Preferably, these batteries 8 would be two or three AG3-type mercury free batteries, sufficient to provide 12-24 hours continuous use.

A further enhancement may be provided wherein a switch mechanism is incorporated the device 1, said mechanism arising where the batteries 8 and the PCB 5 are mounted in the upper and lower casing components (2, 3) in a manner such that a twisting of the upper and lower components (2, 3) relative to one another will bring the power contact points of the PCB 5 into electrical contact with the batteries 8 thereby to switch on the unit 1.

Alternatively, or in addition, there may further be incorporated a switch mechanism whereby the mode of operation of the light source 4 may be switched between different modes, said mechanism being actuated by relative twisting of the upper and lower casing components (2, 3). For example, this switch mechanism may be employed to switch the operation of the light source 4 between a constant beam of light and a flickering beam of light, or may be used to initiate an LED colour changing sequence.

It is preferred to use SMD LEDs for the device, with a light intensity of 300-500 mcd, with a viewing angle of greater than 100°. The LEDs may be of any desired coloured, or there may be provided a number of different coloured LEDs. In addition, the LEDs may be programmed to provide a continuous illumination, or to perform a flashing sequence.

In an alternative embodiment, the lower component of the casing 3 may be formed from plastic, provided the mass of the batteries 8 as depicted results in a centre of gravity located below the join 10 between the upper and lower components of the casing.

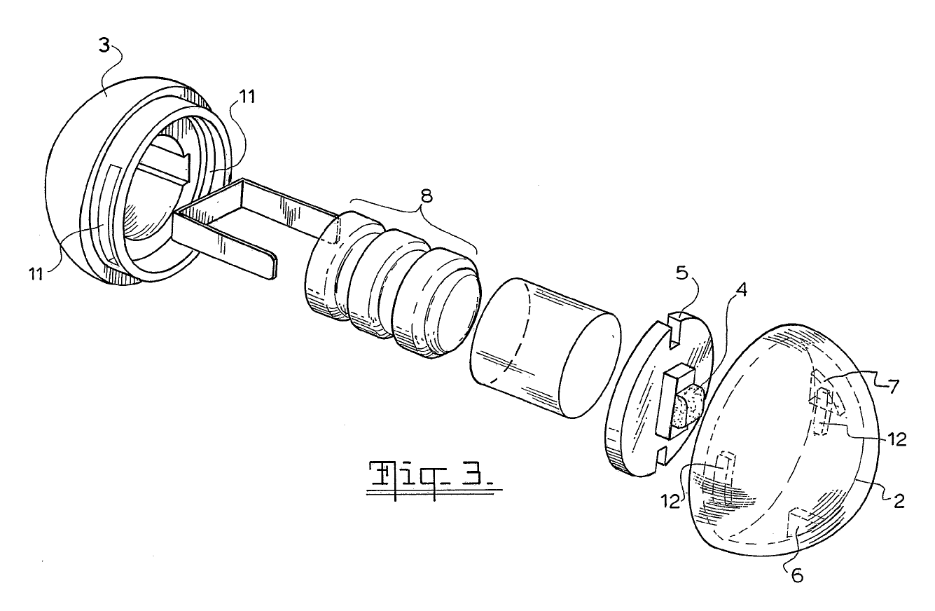

Turning to FIG. 3, there is shown the upper and lower casing components in a disassembled state. It will be noted that there are grooves 11 provided in a peripheral collar 12 attached to the lower casing component 3, which are designed to interact with corresponding notches 12 attached to the internal surface of the upper component 2, to effect releasable closure of the device casing.

In order to allow ease of insertion of the device into the balloon, it is preferred that the external diameter of the device casing is no greater than 14 mm.

Preferably, the mass of the device should be no greater than 9 g.

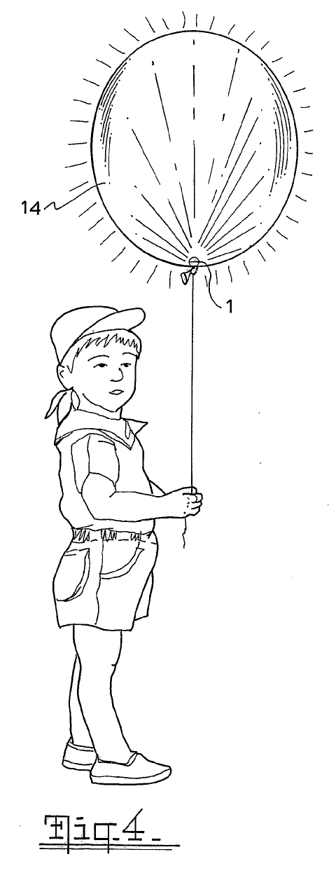

Turning to FIG. 4, there is shown an illumination device 1 as described above, inserted in an inflated balloon 14, and which is illuminating the balloon 14 as it is carried by a child.

The unit as described above is expected to be substantially resistant to the ingress of moisture into the cavity, although not necessarily waterproof.

It will be appreciated by those skilled in the art that the above described embodiment represents merely one way in which the invention can be realised. There will be alternative embodiments, within the skill of the person skilled in the art to construct, which, whilst different in some aspects, will nevertheless fall within the spirit and scope of the invention.

1. An illumination device for insertion entirely inside a typical novelty balloon or the like, said device including:
an outer casing having a lower and an upper component and having a substantially spheroid in overall shape, capable of rolling through at least one full revolution on a flat surface;
a power source mounted inside said outer casing; and
a light generator connected to said power source and mounted inside said outer casing such that light generated by said generator is directed outward substantially through said upper component;
wherein the centre of gravity of said device is located within said lower component of said outer casing.

2. The illumination device of claim 1, wherein said lower component of said outer casing is substantially heavier than said upper component.

3. The illumination device of claim 1, wherein the preferred bottom position of the device is at least partially flattened.

4. The illumination device of claim 1, wherein said lower component of said outer casing is substantially composed of metal Qr high density plastic and said upper component is substantially composed of low density plastic.

5. The illumination device of claim 1, further incorporating a switch mechanism, said mechanism arising from an internal configuration of the power source and the light generator wherein the former is brought into electrical contact with the latter via relative twisting of the upper and lower casing components.

6. The illumination device of claim 1, further incorporating a switch mechanism whereby the mode of operation of the light source may be switched between different modes, said mechanism being actuated by relative twisting of the upper and lower casing components.

7. The illumination device of claim 6, wherein the different modes of operation of the light source include at least a first mode wherein a constant beam of light is emitted by the device and a second mode wherein a flickering light is emitted.

8. The illumination device of claim 6, wherein the different modes of operation of the light source include at least a first mode wherein the beam of light is emitted in a first colour and a second mode wherein the light is emitted in at least one colour different from said first colour.

9. The illumination device of claim 1, wherein said power source is one or more batteries, and said batteries are substantially housed in said lower component of said outer casing.

10. The illumination device of claim 9, wherein said light generator includes one or more light emitting diodes.

11. The illumination device of claim 1, wherein an adhesive substance is applied to the surface of the lower component of the outer casing thereby to allow the device to adhere to a surface.

12. A balloon incorporating an illumination device as defined in claim 1.

13. (canceled)

14. A method, comprising:
(a) locating an illumination device within an inflatable device, the illumination device comprising:
an outer casing having a lower and an upper component and having a substantially spheroid in overall shape, capable of rolling through at least one full revolution on a flat surface;
a power source mounted inside said outer casing; and
a light generator connected to said power source and mounted inside said outer casing such that light generated by said generator is directed outward substantially through said upper component;
wherein the centre of gravity of said device is located within said lower component of said outer casing; and
(b) inflating and sealing the inflatable device.

15. The method of claim 14, wherein said lower component of said outer casing is substantially heavier than said upper component and wherein the preferred bottom position of the device is at least partially flattened.

16. The method of claim 14, wherein said lower component of said outer casing is substantially composed of metal or high density plastic and said upper component is substantially composed of low density plastic and further incorporating a switch mechanism, said mechanism arising from an internal configuration of the power source and the light generator wherein the former is brought into electrical contact with the latter via relative twisting of the upper and lower casing components.

17. The method of claim 14, further incorporating a switch mechanism whereby the mode of operation of the light source may be switched between different modes, said mechanism being actuated by relative twisting of the upper and lower casing components.

18. The method of claim 17, wherein the different modes of operation of the light source include at least a first mode, wherein a constant beam of light is emitted by the device and a second mode wherein a flickering light is emitted, wherein, in the at least a first mode, the beam of light is emitted in a first colour, and wherein, in the second mode, the light is emitted in at least one colour different from said first colour.

19. The method of claim 1, wherein said power source is one or more batteries, and said batteries are substantially housed in said lower component of said outer casing, wherein said light generator includes one or more light emitting diodes, and wherein an adhesive substance is applied to the surface of the lower component of the outer casing thereby to allow the device to adhere to a surface.
